(19) United States
(12) Patent Application Publication
(10) Pub. No.: US 2023/0032202 A1
(43) Pub. Date: Feb. 2, 2023

(54) MULTICOLORED REFLECTIVE LIGHTING

(71) Applicant: GEMMY INDUSTRIES CORPORATION, Coppell, TX (US)

(72) Inventor: Elizabeth Penn, Coppell, TX (US)

(21) Appl. No.: 17/387,629

(22) Filed: Jul. 28, 2021

(51) Int. Cl. F21S 10/02; F21V 33/00

(52) U.S. Cl. CPC F21S 10/026; F21V 33/0032; F21Y 2115/10

(57) ABSTRACT

A multicolored reflective lighting has multiple multicolored films mounted on multiple frame bodies of a lighting frame, and at least one light strip is mounted on the lighting frame. The at least one light strip is configured to be lighted up to project light to the multiple multicolored films. Reflecting the projected light, the multiple multicolored films are able to generate various color changes and light-reflective effects by multiple light-transmitting layers with different refractive indexes. Colors are changeable with view angles. By mutual intersecting light-reflective effects generated by part of light projecting through one of the multiple multicolored films to another, and spaces between the multiple frame bodies, the multicolored reflective lighting generates various three-dimensional multicolored lighting effects. The multicolored reflective lighting is especially suitable for festival decoration, environmental decoration or outdoor display.

### BACKGROUND OF THE INVENTION

### 1. Field of the Invention

The present invention relates to a decorative lighting, especially to a lighting that has a multicolored lighting effect.

### 2. Description of the Prior Arts

A lighting, widely used in daily life, generates decorative lighting effects by projection of light with a three-dimensional shape of the lighting's body.

For improving decorative effects of the lighting, a light-transmitting film is mounted in the three-dimensional lighting's body. The common light-transmitting film is mainly a light-reflecting film, a matte film, etc., or is further formed with hollow holes. With light-emitting elements mounted into the lighting's body, the conventional lighting generates decorative lighting effects by the transparent or translucent light-transmitting film projected by the light emitted from the light-emitting elements.

When the above-mentioned conventional lighting is in use, the decorative lighting effects can be generated on the three-dimensional lighting's body by projecting the light to the light-transmitting film with hollow holes. However, the lighting effects presented by the conventional lighting are monotonous. The conventional lighting cannot generate multicolored decorative lighting effects.

### SUMMARY OF THE INVENTION

The present invention is to resolve the drawback that the conventional lighting lacks decorative lighting effects.

A multicolored reflective lighting of the present invention comprises a lighting frame, multiple multicolored films and at least one light strip. The lighting frame comprises multiple frame bodies, and each two adjacent ones of the frame bodies have a space formed therebetween. The multiple multicolored films are mounted on the multiple frame bodies of the lighting frame. Each one of the multicolored film is a composite laminated film comprising at least two light-transmitting layers having different refractive indexes. The at least one light strip is mounted on the lighting frame, and is configured to be lighted up to project light to the multiple multicolored films. The light-projected multiple multicolored films are able to generate multiple color changes by the different refractive indexes of the multiple light-transmitting layers.

The present invention can generate variable multicolored lighting effects when the light strip projects light to the multiple multicolored films due to the light-permeability, light-reflectivity and multiple-color-changing capability of the multiple multicolored films mounted in the multiple frame bodies of the lighting frame, and due to a spatial configuration that the multiple frame bodies have spaces in between. Furthermore, the present invention generates visual three-dimensional multicolored lighting effects by mutually intersecting light reflection generated by part of light projecting through one to another of the multiple multicolored films. By the particular light-reflective effects, the multiple colors generated by the present invention are variable with changes of view angle. The present invention is especially suitable for festival decoration, environmental decoration, or outdoor display.

The lighting frame of the present invention is a foldable structure. With the foldable light frame, the present invention is configured in a three-dimensional shape when the lighting frame is expanded and is configured in a flat shape when the lighting frame is folded. When in the flat shape, the present invention reduces space occupied and facilitates ease in transporting and storage.

Furthermore, the present invention improves the decorative three-dimensional lighting effects of the lighting frame because the light strip lights up outer shapes of the frame bodies, and each one of the multiple frame bodies of the lighting frame is installed with a respective one of the multiple light strips; said light strip and one of the multicolored films are fixed on said frame body by multiple fixing elements.

### BRIEF DESCRIPTION OF THE DRAWINGS

FIG. 1 is a perspective view of a first embodiment of a multicolored reflective lighting in accordance with the present invention;

FIG. 2 is an another perspective view of the first embodiment of the multicolored reflective lighting in FIG. 1;

FIG. 3 is a partial enlarged perspective view of the first embodiment of the multicolored reflective lighting in FIG. 1;

FIG. 4 is a side view of the first embodiment of the multicolored reflective lighting in FIG. 1;

FIG. 5 is a rear view of the first embodiment of the multicolored reflective lighting in FIG. 1;

FIG. 6 is an exploded perspective view of the first embodiment of the multicolored reflective lighting in FIG. 1;

FIG. 7 is a partial exploded perspective view of the first embodiment of the multicolored reflective lighting in FIG. 6;

FIG. 8 is a perspective view of the first embodiment of the multicolored reflective lighting in FIG. 7 in another configuration;

FIG. 9 is a perspective view of a second embodiment of the multicolored reflective lighting in accordance with the present invention;

FIG. 10 is a side view of the second embodiment of the multicolored reflective lighting in FIG. 9;

FIG. 11 is a perspective view of a lighting frame of the second embodiment of the multicolored reflective lighting in FIG. 9 and FIG. 10;

FIG. 12 is a perspective view of a third embodiment of the present invention, shown without at least one light strip;

FIG. 13 is a bottom view of the third embodiment of the present invention, shown without the at least one light strip;

FIG. 14 is a perspective view of the lighting frame of the third embodiment of the multicolored reflective lighting in FIG. 12 and FIG. 13;

FIG. 15 is a side sectional view of the third embodiment in FIG. 13, shown without the at least one light strip;

FIG. 16 is a partial enlarged perspective view of the third embodiment of the multicolored reflective lighting in FIG. 12.

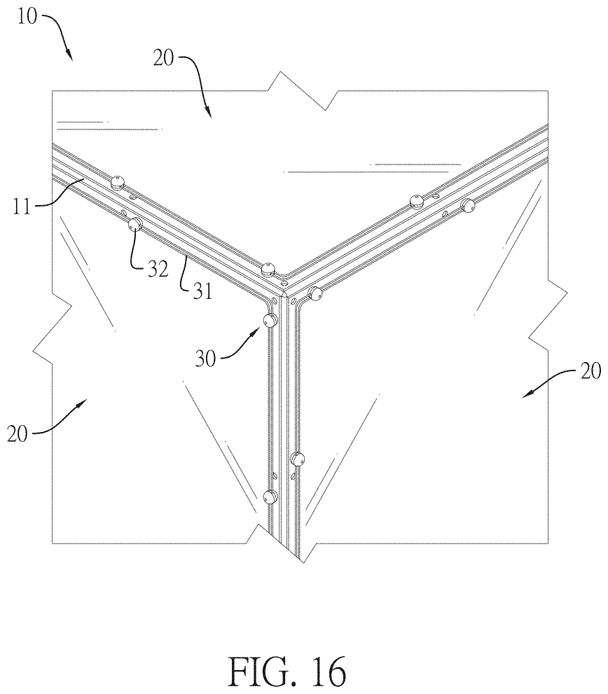

### DETAILED DESCRIPTION OF THE PREFERRED EMBODIMENTS

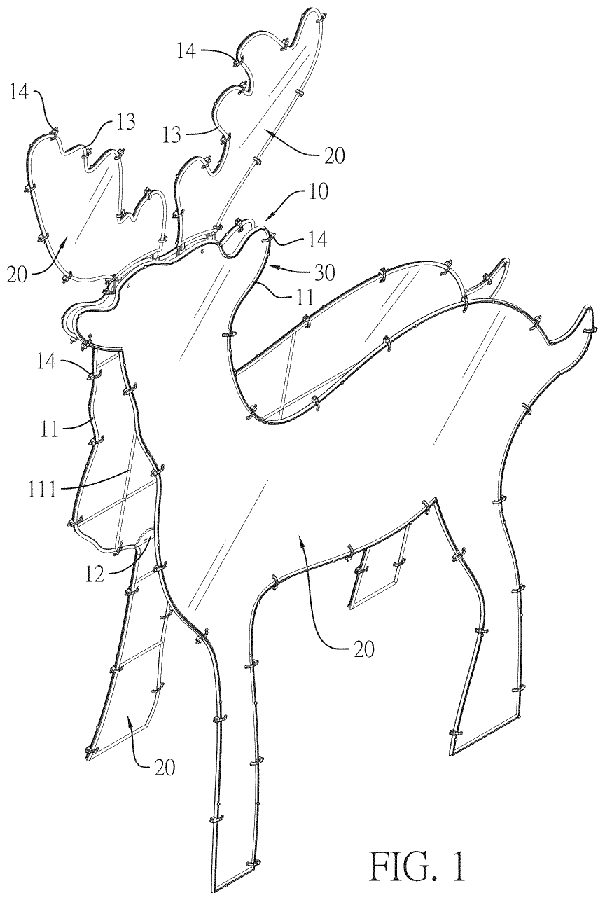

FIGS. 1, 9 and 12 are embodiments of a multicolored reflective lighting in accordance with the present invention. The multicolored reflective lighting comprises a lighting frame 10, multiple multicolored films 20 and at least one light strip 30.

The lighting frame 10 comprises multiple frame bodies 11. Each two adjacent ones of the frame bodies 11 have a space formed therebetween such that the lighting frame 10 is in a three-dimensional shape. The lighting frame 10 may be in a shape of an animal, a plant, a star or any other shape depending on design. The lighting frame 10 may be a personal accessory, an ornament on a table, or a decoration on the ground, etc. Multiple reinforcing sticks 111 may be mounted in the multiple frame bodies 11 to enhance structural strength of the multiple frame bodies 11.

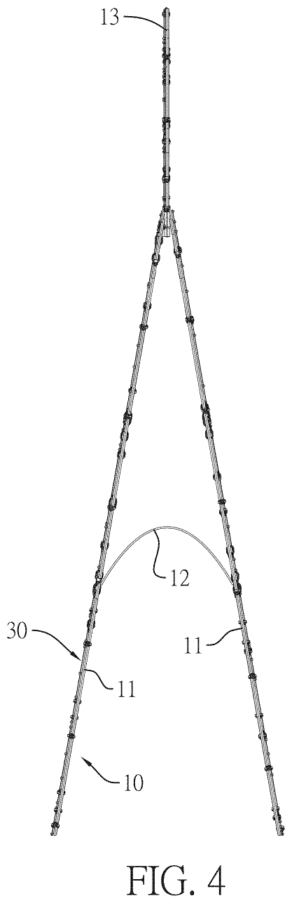

With reference to FIGS. 1, 2 and 4, in a preferred embodiment, an amount of the multiple frame bodies 11 is two. Upper ends of the two frame bodies 11 are connected to each other, and lower ends of the two frame bodies 11 are expandable and foldable relative to each other. A connecting element 12 is mounted between middle segments of the two frame bodies 11. The connecting element 12 may be a rigid or flexible element. The connecting element 12 limits a range of an expanded angle of the two frame bodies 11. Thus, the lighting frame 10 is foldable and expandable. The lighting frame 10 forms an A-shape seen from a side view when expanded.

Besides, in a preferred embodiment, one or multiple fixing hooks may be mounted between bottom ends of the two frame bodies 11. The fixing hook(s) can fix the shape of the lighting frame 10 after the lighting frame 10 is expanded.

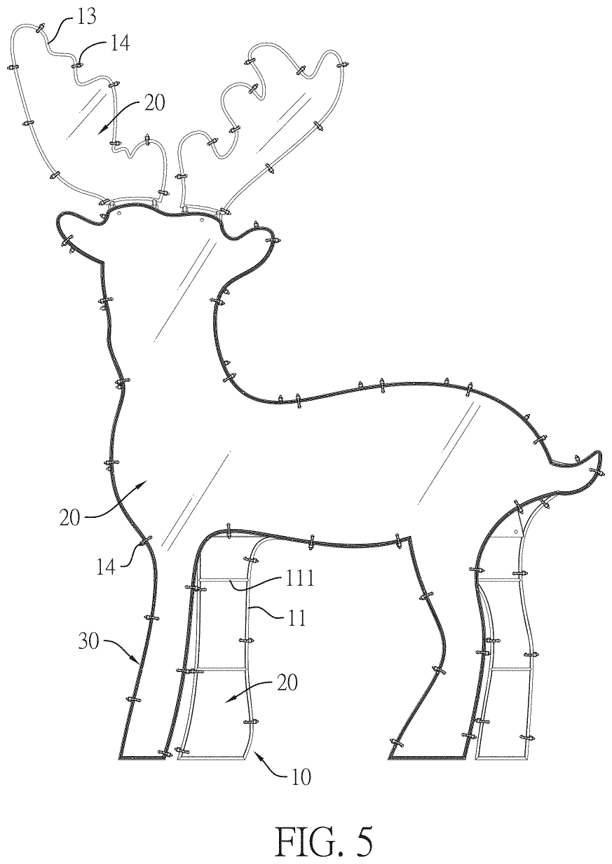

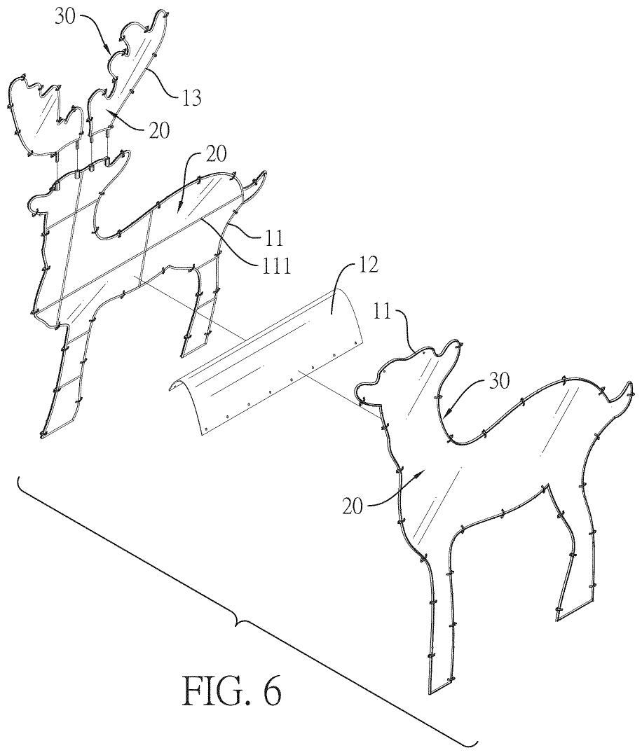

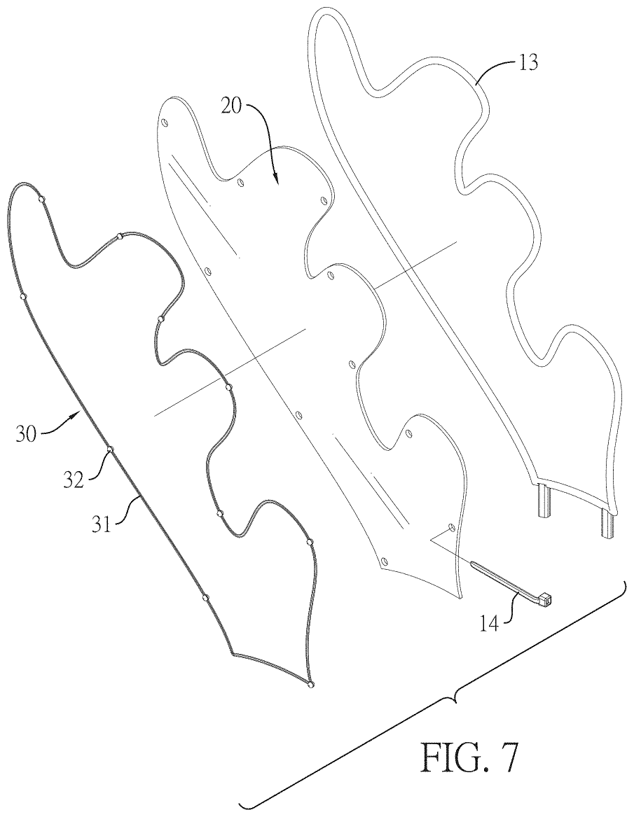

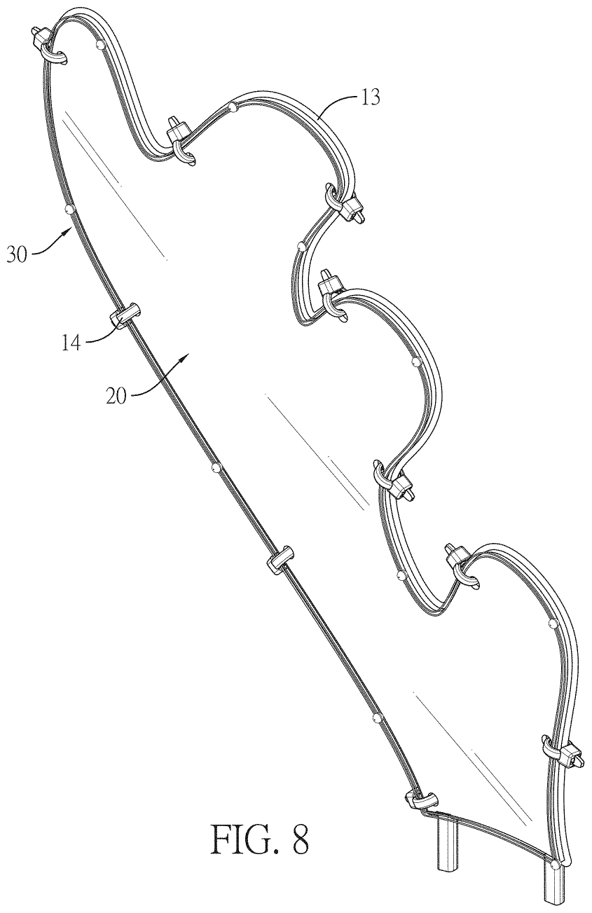

Furthermore, with reference to FIGS. 1, 2 and 5 to 8, the lighting frame 10 may comprise one or multiple decorating frames 13 depending on demand. By mounting the decorating frame(s) 13 on the frame body 11, the lighting frame 10 is able to make diverse styling changes.

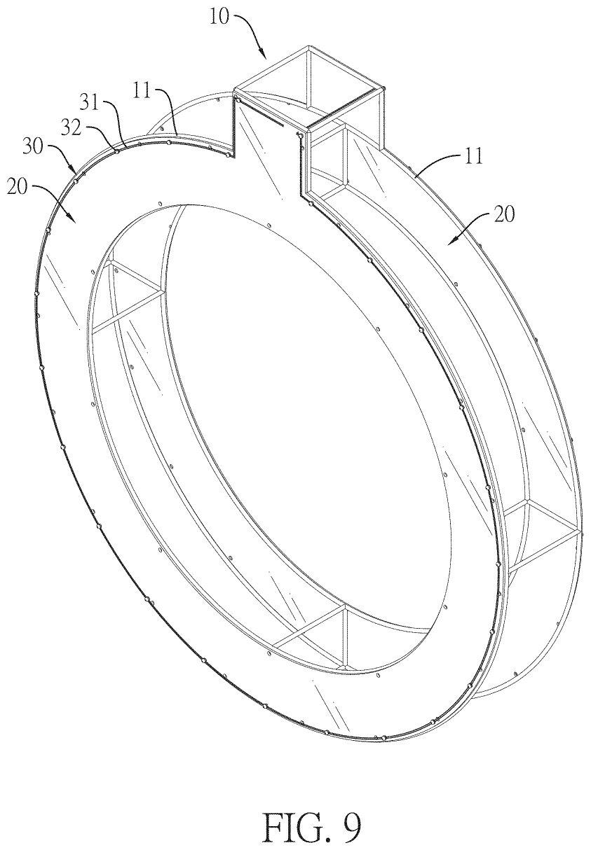

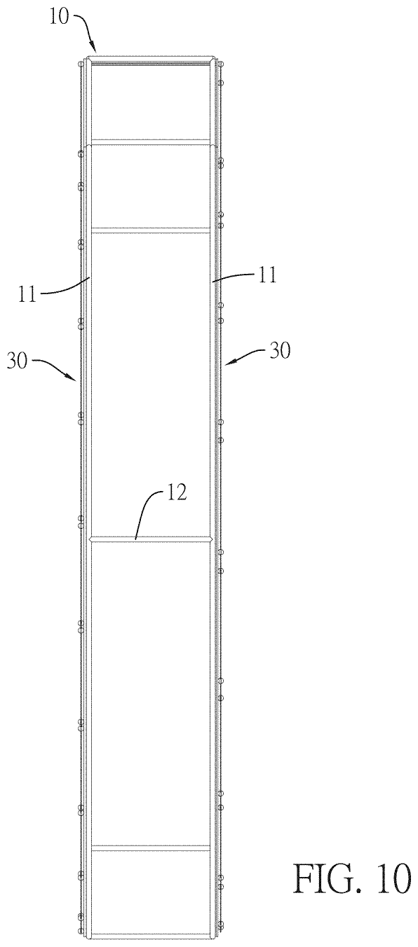

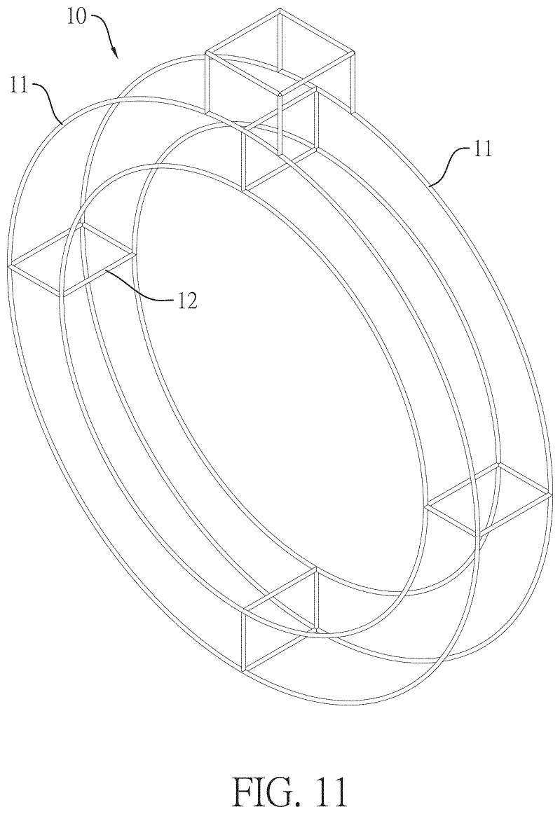

The two frame bodies 11 of the lighting frame 10 may be spaced apart from each other. The connecting element 12 is mounted between the two frame bodies 11. The lighting frame 10 forms an H-shape seen from a side view. The lighting frame 10 may be a foldable or non-foldable structure. In a preferred embodiment, when the lighting frame 10 is a foldable structure, the one or multiple fixing hooks may be mounted between bottom ends of the two frame bodies 11. The fixing hook is able to maintain the shape of the expanded lighting frame 10 firmly. Moreover, with reference to FIGS. 9 to 11, multiple connecting elements 12 are mounted between the two frame bodies 11, and the two frame bodies 11 are spaced apart from each other. The multiple connecting elements 12 are able to maintain the shape of the lighting frame 10 firmly.

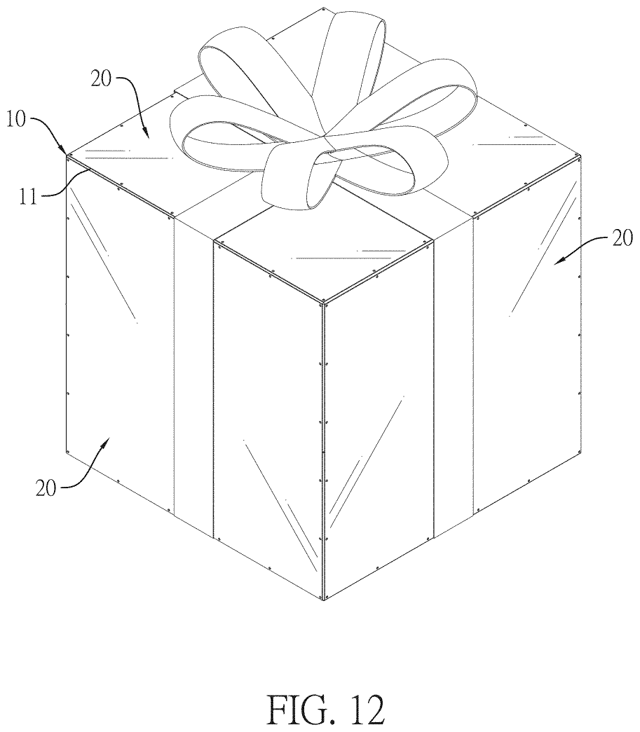

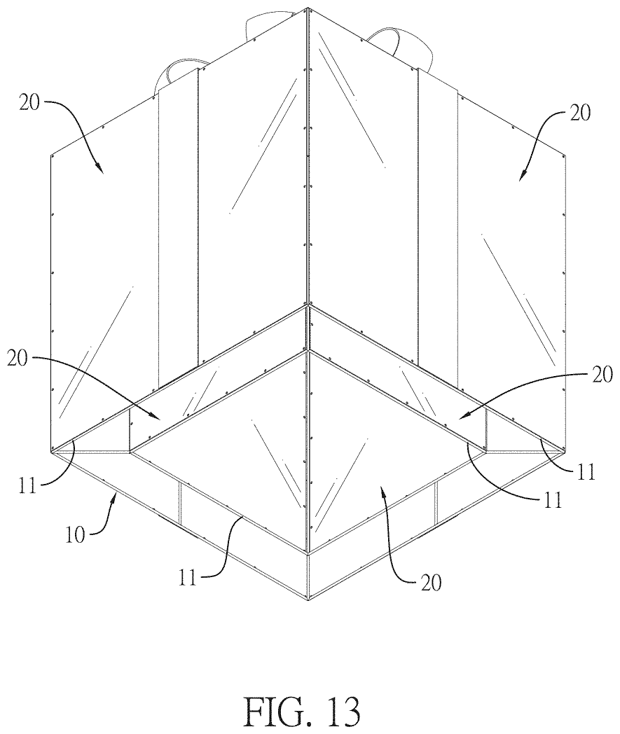

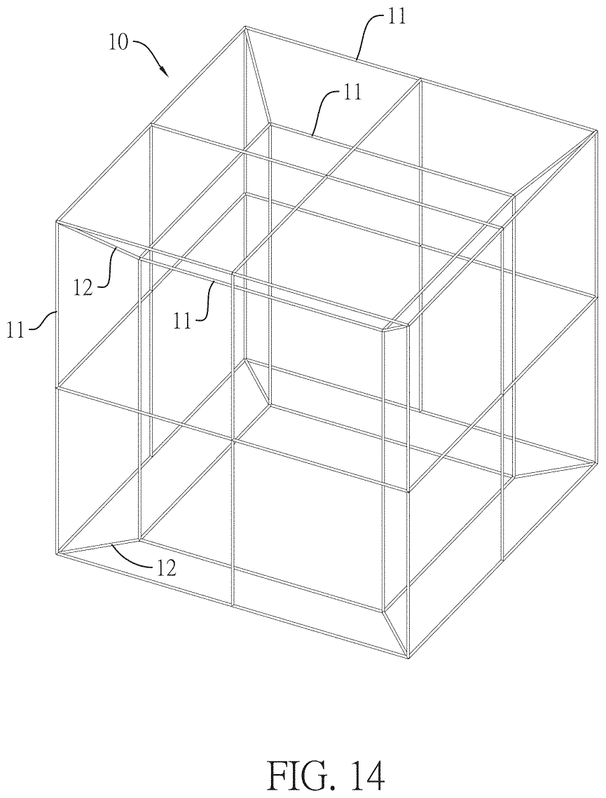

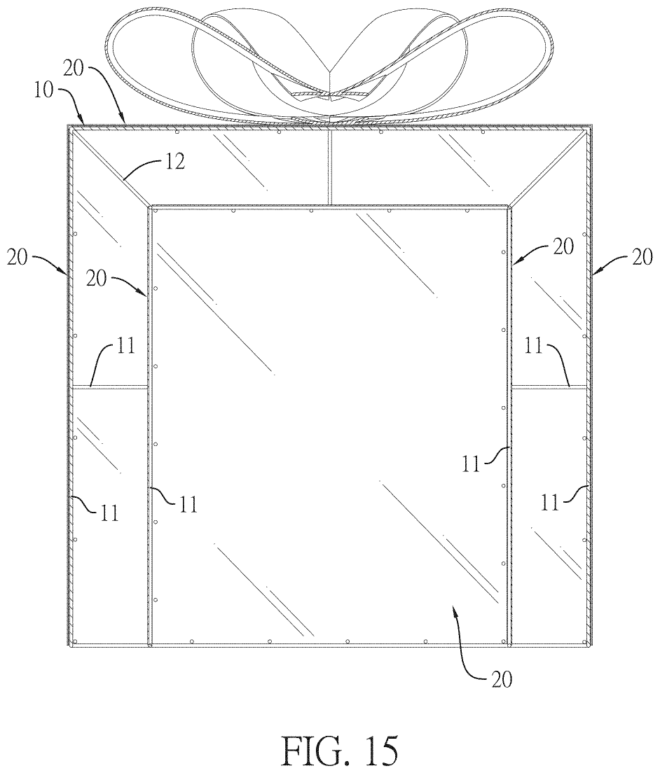

In addition to the above-mentioned preferred embodiment, the lighting frame 10 may form a single-layer three-dimensional frame with the multiple frame bodies 11. Alternatively, the lighting frame 10 may be a three-dimensional frame with the multiple frame bodies 11 connected to form an inner layer and an outer layer, and the inner layer is disposed inside the outer layer. With reference to FIGS. 12 to 15, the preferred embodiment is a three-dimensional square structure with the inner layer and the outer layer. Both of the inner layer and the outer layer of the preferred embodiment are squares composed by the multiple frame bodies 11 connected by the multiple connecting elements 12.

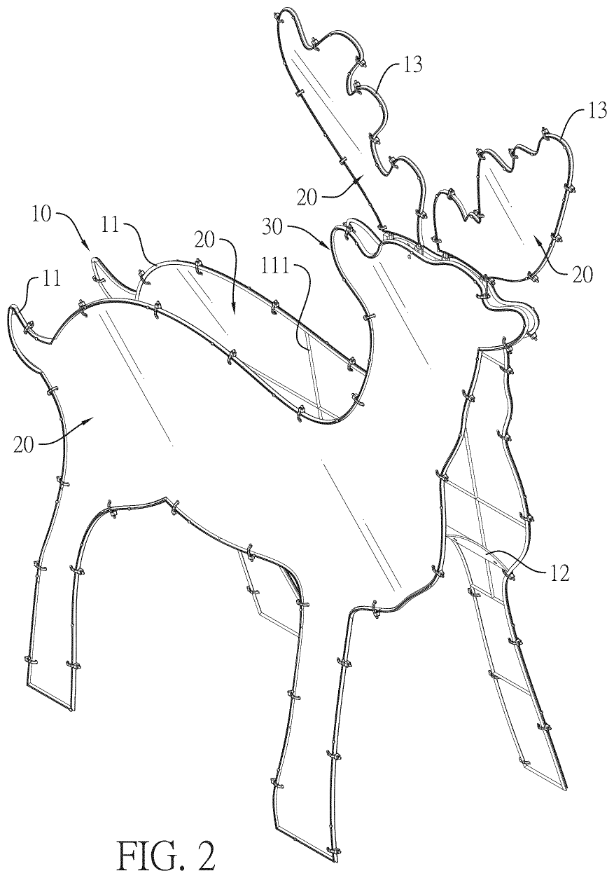

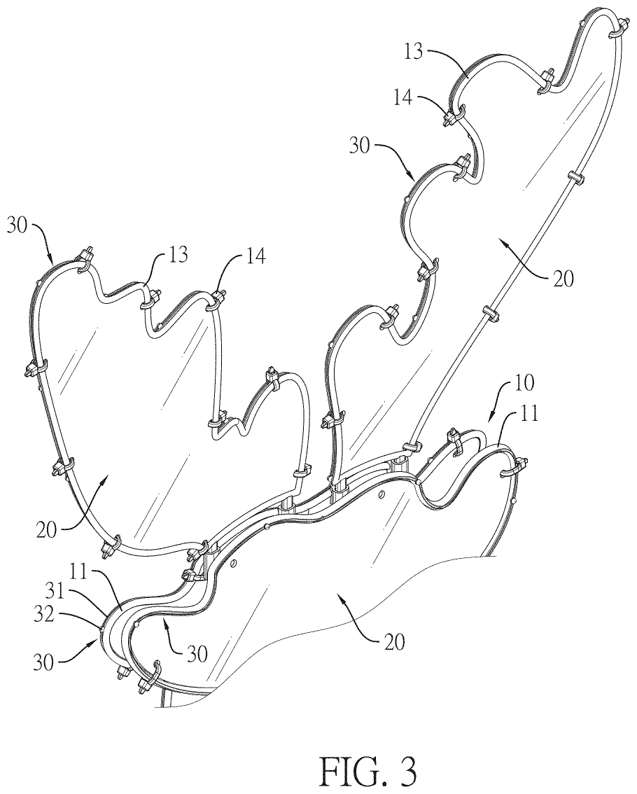

With reference to FIGS. 1 to 3, 9, 12 to 13, the multiple multicolored films 20 are mounted in the lighting frame 10 separately. Each of the multiple multicolored films 20 is mounted on a respective one of the multiple frame bodies 11 of the lighting frame 10. In the preferred embodiment, a contour of the multicolored film 20 substantially matches a contour of the frame body 11. Furthermore, an edge of the multicolored film 20 is fixed on the frame body 11 by multiple fixing elements 14 or by pasting. The multicolored film 20 can be a film without a hole, or a film having one or multiple hollow holes. The multiple fixing elements 14 can be elements such as cable ties, iron threads, cotton threads, or any other wires. With reference to FIGS. 1 to 2, when the lighting frame 10 has the decorating frame 13, the multicolored film 20 may be mounted on the decorating frame 13.

The multicolored film 20 is a composite laminated film comprising at least two light-transmitting layers having different refractive indexes. The multicolored film 20 generates multi-color changes by the principle of refraction and with the multiple layers having different refractive indexes. Furthermore, by changing view angles or changing materials of the light-transmitting layer, the multicolored film 20 generates variations of light and colors. In the preferred embodiment, a material of the multicolored film 20 can be selected from PET (polyethylene terephthalate) layer, PVC (Polyvinyl Chloride) layer, TPE (Thermoplastic Elastomer) layer, or any combination thereof.

With reference to FIG. 1, 2, 4, 5, 9, 10 or 16, the at least one light strip 30 is mounted on the lighting frame 10. The at least one light strip 30 is configured to be lighted up to project light to the multiple multicolored films 20. The at least one light strip 30 is configured to be lighted up by connecting to a power supply directly. Alternatively, the at least one light strip 30 is configured to be lighted up by connecting to the power supply through a controller. In the preferred embodiment, the light strip 30 is an LED (light-emitting diode) light strip 30 with low power consumption. The LED light strip 30 comprises a wire set 31 and multiple LEDs 32. The multiple LEDs 32 are electrically connected to the wire set 31 and are spaced apart from each other. The LED 32 may be a single-color LED element or a RGB LED (Red, Green and Blue LED) element, which can emit lights of various colors. Depending on demand, an amount of the at least one light strip 30 may be one or multiple. In the preferred embodiment, an amount of the at least one light strip 30 is multiple. Each one of the multiple frame bodies 11 of the lighting frame 10 is installed with a respective one of the multiple light strips 30, said light strip 30 and one of the multiple multicolored films 20 are fixed on said the frame body 11 by multiple fixing elements 14. With reference to FIGS. 1, 2 and 5 to 8, when the lighting frame 10 comprises the decorating frame 13, the light strip 30 can be mounted on the decorating frame 13.

When in use, the multicolored reflective lighting can be set on the ground, on a table or on any other object that can bear the weight of the multicolored reflective lighting. The multicolored reflective lighting may be an interior or outdoor decoration as shown in FIGS. 1 and 2, a present box as shown in FIG. 12, etc. The multicolored reflective lighting also can be a personal wearable accessory as shown in FIG. 9. Connected to a power supply directly or through a controller, the light strip 30 is configured to be lighted up to project light to the multicolored film 20 in the lighting frame 10. Due to the light-permeability, light-reflectivity and multi-color changing capability of the multiple multicolored films mounted in the multiple frame bodies of the lighting frame, and due to the spatial configuration that the multiple frame bodies have spaces in between, the multicolored reflective lighting can generate various multicolored lighting effects when the light strip 30 projects light to the multiple multicolored films 20. Furthermore, the present invention generates multiple three-dimensional multicolored lighting effects by mutually intersecting light-reflective effects generated by part of light projected through one to another of the multiple multicolored films 20. By the particular light-reflective effects, the multiple colors generated by the present invention may change with view angles. The present invention is especially suitable for festival decorations, environmental decorations, and outdoor display.

Furthermore, the present invention is able to improve the decorative three-dimensional lighting effects of the lighting frame 10 because the light strip 30 lights up outer shapes of the frame bodies 11 on each of the multiple frame bodies 11. The light strip 30 is mounted on each of the multiple frame bodies 11 of the lighting frame 10, and fixed on the frame body 11 together with the multicolored film 20 by multiple fixing elements 14.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multicolored reflective lighting comprising:
a lighting frame comprising
multiple frame bodies, each two adjacent ones of the frame bodies having a space formed therebetween;
multiple multicolored films mounted on the multiple frame bodies of the lighting frame, each one of the multicolored film being a composite laminated film comprising at least two light-transmitting layers having different refractive indexes; and
at least one light strip mounted on the lighting frame, the at least one light strip configured to be lighted up to project light to the multiple multicolored films, the light-projected multiple multicolored films configured to generate multiple color changes by the different refractive indexes of the multiple light-transmitting layers.

2. The multicolored reflective lighting as claimed in claim 1, wherein
an amount of the multiple frame bodies is two, upper ends of the two frame bodies are connected to each other, and lower ends of the two frame bodies are expandable and foldable relative to each other; and
a connecting element is mounted between middle segments of the two frame bodies such that the lighting frame forms an A-shape in a side view when the lighting frame is expanded.

3. The multicolored reflective lighting as claimed in claim 1, wherein
an amount of the multiple frame bodies is two, and the two frame bodies are spaced apart from each other; and
at least one connecting element is mounted between the two frame bodies.

4. The multicolored reflective lighting as claimed in claim 1, wherein
the multiple frame bodies are connected to form an inner layer and an outer layer, and the inner layer is disposed inside the outer layer such that the lighting frame is a three-dimensional frame; and
multiple connecting elements are connected between the inner layer of the lighting frame and the outer layer of the lighting frame.

5. The multicolored reflective lighting as claimed in claim 1, wherein an amount of the at least one light strip is multiple, each one of the multiple frame bodies of the lighting frame is installed with a respective one of the multiple light strips; said light strip and one of the multicolored films are fixed on said frame body by multiple fixing elements.

6. The multicolored reflective lighting as claimed in claim 2, wherein an amount of the at least one light strip is multiple, each one of the multiple frame bodies of the lighting frame is installed with a respective one of the multiple light strips; said light strip and one of the multicolored films are fixed on said frame body by multiple fixing elements.

7. The multicolored reflective lighting as claimed in claim 3, wherein an amount of the at least one light strip is multiple, each one of the multiple frame bodies of the lighting frame is installed with a respective one of the multiple light strips; said light strip and one of the multicolored films are fixed on said frame body by multiple fixing elements.

8. The multicolored reflective lighting as claimed in claim 4, wherein an amount of the at least one light strip is multiple, each one of the multiple frame bodies of the lighting frame is installed with a respective one of the multiple light strips; said light strip and one of the multicolored films are fixed on said frame body by multiple fixing elements.

9. The multicolored reflective lighting as claimed in claim 5, wherein
the light strip is an LED light strip and comprises
a wire set; and
multiple LEDs electrically connected to the wire set and spaced apart from each other.

10. The multicolored reflective lighting as claimed in claim 6, wherein
the light strip is an LED light strip and comprises
a wire set; and
multiple LEDs electrically connected to the wire set and spaced apart from each other.

11. The multicolored reflective lighting as claimed in claim 7, wherein
the light strip is an LED light strip and comprises
a wire set; and
multiple LEDs electrically connected to the wire set and spaced apart from each other.

12. The multicolored reflective lighting as claimed in claim 8, wherein
the light strip is an LED light strip and comprises
a wire set; and
multiple LEDs electrically connected to the wire set and spaced apart from each other.

13. The multicolored reflective lighting as claimed in claim 1, wherein
the lighting frame comprises
at least one decorating frame mounted on the frame body, and the multicolored films mounted in the at least one decorating frame.

14. The multicolored reflective lighting as claimed in claim 2, wherein
the lighting frame comprises
at least one decorating frame mounted on the frame body, and the multicolored films mounted in the at least one decorating frame.

15. The multicolored reflective lighting as claimed in claim 3, wherein
the lighting frame comprises
at least one decorating frame mounted on the frame body, and the multicolored films mounted in the at least one decorating frame.

16. The multicolored reflective lighting as claimed in claim 13, wherein
each of the at least one decorating frame of the lighting frame is installed with a respective one of the multiple light strips; said light strip and one of the multicolored films are fixed on the decorating frame by multiple fixing elements.

17. The multicolored reflective lighting as claimed in claim 14, wherein
each of the at least one decorating frame of the lighting frame is installed with a respective one of the multiple light strips; said light strip and one of the multicolored films are fixed on the decorating frame by multiple fixing elements.

18. The multicolored reflective lighting as claimed in claim 15, wherein
each of the at least one decorating frame of the lighting frame is installed with a respective one of the multiple light strips; said light strip and one of the multicolored films are fixed on the decorating frame by multiple fixing elements.

19. The multicolored reflective lighting as claimed in claim 16, wherein the light strip is an LED light strip and comprises
a wire set; and
multiple LEDs electrically connected to the wire set and spaced apart from each other.

20. The multicolored reflective lighting as claimed in claim 17, wherein the light strip is an LED light strip and comprises
a wire set; and
multiple LEDs electrically connected to the wire set and spaced apart from each other.
